(19) United States
(12) Patent Application Publication
(10) Pub. No.: US 2026/0228057 A1
(43) Pub. Date: Aug. 6, 2026

(54) FEDERATED RUNTIME COMPOSITION FOR DISTRIBUTED WORKLOADS

(71) Applicant: TAHO, INC., Venice, FL (US)

(72) Inventors: Tyson Midboe, Minneapolis, MN (US); Daniel Henning, San Jose, CA (US)

(21) Appl. No.: 19/451,944

(22) Filed: Jan. 16, 2026

Related U.S. Application Data
(60) Provisional application No. 63/746,802, filed on Jan. 17, 2025.

(51) Int. Cl. G06F 9/50; G06F 8/65

(52) U.S. Cl. CPC G06F 9/5083; G06F 8/65

(57) ABSTRACT

Techniques for providing federated runtime composition for distributed workloads are disclosed. In an example method, a first host computing system executes program code including an operation to be executed by a federated application. The first host establishes a channel with hosts accessible via a network. The first host receives, from a second host, information identifying a source for one or more of (1) second program code to execute the first application, in which the second program code include an adapter configured to facilitate the execution of the operation locally by the first application on the first host or by dispatching the operation for execution by the first application on a third host, or (2) the first application. The first host receives the adapter. The first host executes the operation by executing the adapter to cause the federated application to execute on the first host or the third host.

### CROSS-REFERENCE TO RELATED APPLICATIONS

This application claims priority to provisional application U.S. Ser. No. 63/746,802 entitled “Federated Microservices” and filed on Jan. 17, 2025, the entire disclosure of which is incorporated herein by reference for any purpose.

### FIELD

The present disclosure relates to distributed application architectures and, more specifically, to techniques for providing federated runtime composition for distributed workloads.

### BACKGROUND

Distributed, computationally intensive applications such as certain microservices, data-processing pipelines, machine learning training and inference jobs, or streaming systems may be executed as container images using a shared compute pool managed by a container orchestrator. In this deployment model, the orchestrator exercises centralized control over executing workloads by pulling container images from a registry according to a configuration file, creating collections of containers, applying resource and placement constraints, and configuring networking and storage. Scaling can occur manually or automatically in response to changing demand, with the orchestrator adjusting the number of running containers according to observed metrics.

### BRIEF SUMMARY

Techniques for providing federated runtime composition for distributed workloads are disclosed. In one general aspect, a method may include executing, by a first host, first program code having an operation to be executed by a first application. The method may also include establishing, by the first host, a communication channel with one or more hosts accessible via a network. The method may furthermore include, from a second host accessible via the network, receives information identifying a source for one or more of (1) second program code to execute the first application, in which the second program code includes an adapter configured to facilitate the execution of the operation locally by the first application on the first host or by dispatching the operation for execution by the first application on a third host, or (2) the first application. The method may in addition include receiving, by the first host, the second program code. The method may moreover include executing, by the first host, the operation including executing the second program code to cause the first application to execute on the first host or the third host.

In another general aspect, a non-transitory computer-readable storage medium may store processor-executable instructions configured to cause one or more processors to execute, by a first host, first program code having an operation to be executed by a first application; establish, by the first host, a communication channel with one or more hosts accessible via a network; from a second host accessible via the network, receive information identifying a source for one or more of (1) second program code to execute the first application, in which the second program code includes an adapter configured to facilitate the execution of the operation locally by the first application on the first host or by dispatching the operation for execution by the first application on a third host, or (2) the first application; receive, by the first host, the second program code; and execute, by the first host, the operation including executing the second program code to cause the first application to execute on the first host or the third host.

In another general aspect, a system may include one or more non-transitory computer-readable media. The system may also include one or more processors communicatively coupled to the one or more non-transitory computer-readable media, the one or more processors configured to execute processor-executable instructions stored in the non-transitory computer-readable media to: execute, by a first host, first program code having an operation to be executed by a first application; establish, by the first host, a communication channel with one or more hosts accessible via a network; from a second host accessible via the network, receive information identifying a source for one or more of (1) second program code to execute the first application, in which the second program code includes an adapter configured to facilitate the execution of the operation locally by the first application on the first host or by dispatching the operation for execution by the first application on a third host, or (2) the first application; and execute, by the first host, the operation including executing the second program code to cause the first application to execute on the first host or the third host.

### BRIEF DESCRIPTION OF THE DRAWINGS

The accompanying drawings, which are incorporated into and constitute a part of this specification, illustrate one or more certain examples and, together with the description of the examples, serve to explain the principles and implementations of the certain examples.

FIGS. 1A and 1B show a system for providing federated runtime composition for distributed workloads, according to some aspects of the present disclosure.

FIG. 2 shows a flowchart of an example method for providing federated runtime composition for distributed workloads by a host, according to some aspects of the present disclosure.

FIG. 3 shows a flowchart of an example method for providing federated runtime composition for distributed workloads by a network provider, according to some aspects of the present disclosure.

FIG. 4 shows a flowchart of an example method for providing federated runtime composition for distributed workloads by multiple hosts, according to some aspects of the present disclosure.

FIG. 5 shows an example computing device suitable for use in example systems or methods for providing federated runtime composition for distributed workloads, according to some examples of the present disclosure.

### DETAILED DESCRIPTION

Examples are described herein in the context of providing federated runtime composition for distributed workloads. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application-and business-related constraints, and that these specific goals will vary from one implementation to another and from one developer to another.

### Overview

Modern distributed applications may be deployed to cloud native architectures. Cloud native architectures may involve containerized, declaratively managed workloads on immutable infrastructure using container orchestrators such as Kubernetes. In this paradigm, applications are typically configured as compositions of loosely coupled services that are built, deployed, and operated through automated control planes rather than manual management of application servers.

Cloud native architectures may involve other changes to traditional application management such as externalization of application state, infrastructure provisioned using code, deployment of immutable artifacts, and so on. Container orchestrators may provide declarative application programming interfaces (APIs) for managing and configuring state, scheduling, service discovery, scaling, rollout, and failure recovery, and so on.

For example, traditional approaches to integrating and scaling software components in a distributed workload, such as an application built up from microservices, can involve employing a traditional microservices architecture combined with centralized orchestration and coordination mechanisms, such as API gateways or service meshes. In such configurations, each microservice is typically individually packaged and deployed. Integration is handled through network-based calls, sometimes complemented by specialized federation or specialized message brokers. Such approaches involve substantial operational overhead, complicated integration and deployment pipelines, and complex dependency management.

Another existing approach involves using containerization and virtualization technologies to package and isolate services. Such tools can be used to scale components independently and integrate them via standardized protocols and registries. However, this approach retains the drawbacks of significant infrastructure complexity, build-time coupling of dependencies, and a reliance on network-heavy, potentially latency-prone integration points.

These existing approaches to implementing cloud native architectures using containers and centralized provisioning systems cannot scale to meet the growing demand for compute-intensive workloads such as those associated with artificial intelligence (AI). The orchestration approach assumes rapid, lightweight container startup on general-purpose nodes. However, specialized, computationally intensive workloads such as AI workloads typically require tightly coupled GPU resources, large contiguous memory regions, high-throughput interconnects, and predictable scheduling across multiple GPUs or nodes.

Moreover, compute-intensive workloads require a deployment model in which the executing software can be placed onto different nodes as its resource needs change, such as selecting nodes that provide groups of tightly interconnected GPUs at the start of an AI training phase and then shifting or resizing those placements as the job's parallelism evolves. Existing approaches cannot perform this type of runtime reorganization because placement decisions and resource assignments are fixed once the workload is scheduled, relying on static declarations made before execution.

These shortcomings and challenges can be addressed using federated runtime composition for distributed workloads, according to this disclosure. The disclosed techniques can be used to implement federated data processing, in which domain logic for distributed applications is dynamically imported by a host at runtime rather than being integrated using network-based calls. Additionally, in federated data processing, computational workloads are distributed among a number of hosts, including hosts not traditionally involved with computation, such as frontend, backend, mobile, edge, embedded/IoT devices, and so on. Such hosts may execute all components of a distributed application using techniques such as runtime binding and modular code composition.

For example, components of distributed applications such as microservices can execute locally on a host rather than on a remote server without being installed on the host. The components can be dynamically retrieved from a network that can be logically represented as a network overlay or “fabric” that includes one or more local or remote hosts. When a component is updated, the host can detect the availability of a new version (e.g., by polling for an update flag or other notification mechanism) and automatically retrieve and execute the new version of the component upon next use of the component. Federated runtime composition for distributed workloads thus enables seamless updates, portable deployment of cross-platform program code, and adaptive workflows and reduces deployment overhead, all without disrupting the user experience.

In an example method, provided to illustrate certain concepts, consider a host executing an application that includes an operation to be executed by a federated application. For instance, the operation may be a method provided by a microservice implementing a domain model. The domain model is sometimes described as providing a number of ports, each of which corresponds to an operation performed by a federated application. The method implementation can be dynamically retrieved from a network overlay or fabric which includes numerous local or remote hosts including the host itself. The method can be executed locally on the host rather than on a remote server without the federated application being installed on the host.

To do this, the host joins the fabric and receives information about another host executing on the network that is configured to provide an adapter. The adapter is configured to either execute the method on the federated application executing locally or to dispatch the invocation to the federated application executing on a remote host, depending on the availability of computational resources on the host and throughout the fabric. The host receives the adapter from the other host and executes the method via the adapter to cause the operation to execute on either the host or the other host. Interfacing with the fabric is handled by the adapter, whether locally or remotely and the application itself is agnostic to both the implementation and execution details of the federated application.

The techniques according to this disclosure constitute significant improvements to distributed application technologies. In particular, federated runtime composition for distributed workloads enable deployed applications to benefit from the advantages of monolithic applications and microservice-based applications, while eliminating some of their drawbacks. For example, distributed applications using federated runtime composition enjoy deployment independence, which enables efficient scaling by minimizing interdependencies. Federated components of such distributed applications can be updated live, at runtime, without interrupting client connections to other components. Data privacy is improved because federated execution enables logic and data-handling methods to be dynamically integrated closer to where the data originates, either in a local environment or at the network's edge with stronger access controls and reduced attack surface, rather than pushing data to untrusted clouds.

Federated architecture according to this disclosure, when used to implement AI use cases, can yield dynamic, extensible, and performant inference pipelines. Traditional AI workflows often involve monolithic services or tightly coupled pipelines. Federated components can be flexibly composed, updated at runtime, and distributed across multiple computing layers including CPU, GPUs, edge devices, and browsers, without the downsides of the highly centralized AI architectures used in existing systems. With a federated architecture according to this disclosure, each segment of the AI workflow (data ingestion, feature extraction, model inference, result interpretation, etc.) can be implemented as a separate federated application. Each federated application can be loaded and invoked on-demand, scaling out across multiple servers and specialized hardware for performance, or executed in-memory and on-edge for latency-sensitive scenarios. As network conditions change, such as a sudden spike in inference requests or the introduction of a new model version, federated applications can be swapped, replicated, or migrated to different hosts as needed, without lengthy redeployment cycles. As a result, inference latency can drop dramatically, privacy can improve as data stays within the host's environment, and the network experiences improved resilience and flexibility.

These illustrative examples are given to introduce the reader to the general subject matter discussed herein and the disclosure is not limited to these examples. The following sections describe various additional non-limiting examples of systems and methods for federated runtime composition for distributed workloads.

### Example Systems for Providing Federated Runtime Composition for Distributed Workloads

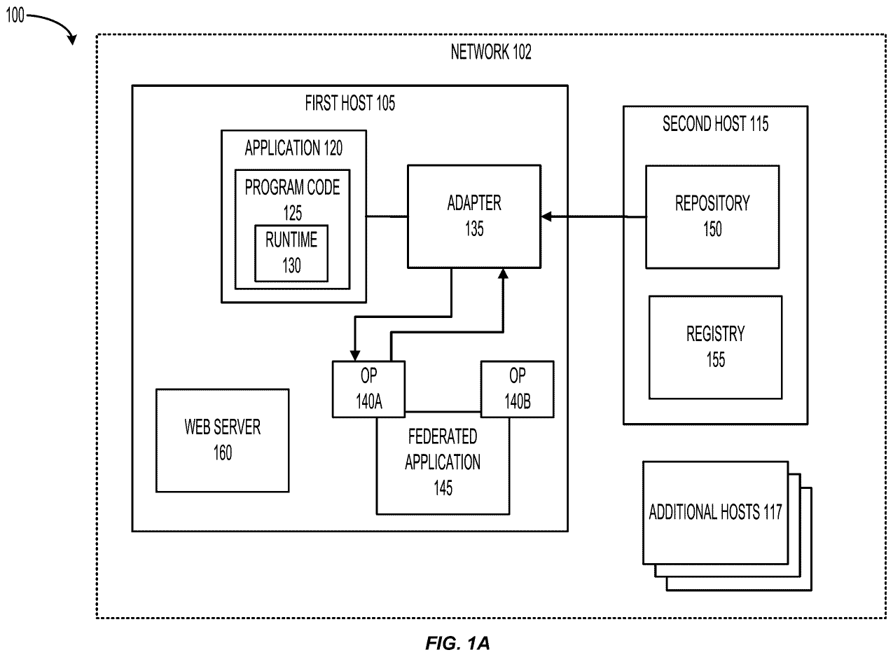

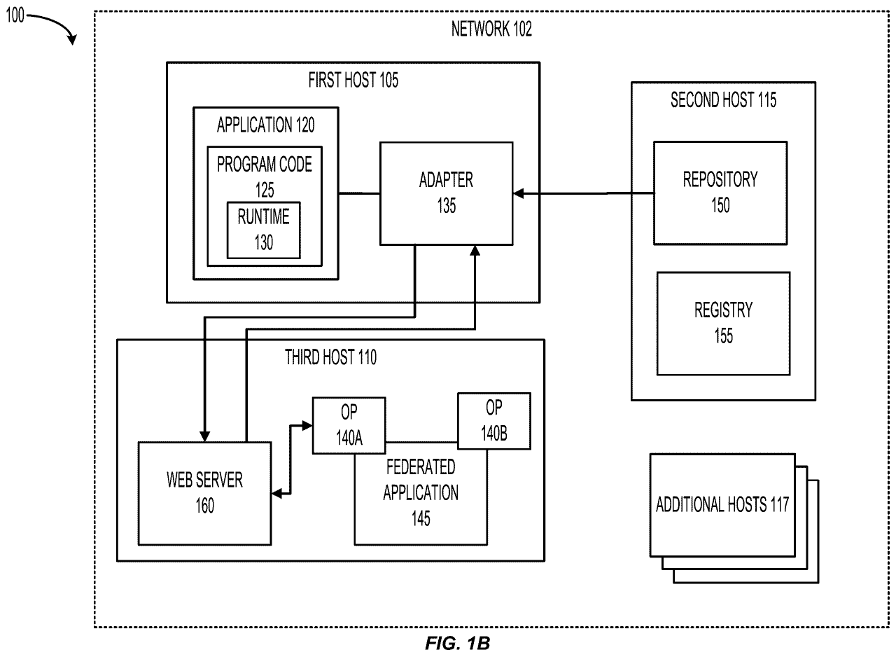

Turning first to FIGS. 1A and 1B, FIGS. 1A and 1B show a system for providing federated runtime composition for distributed workloads, according to some aspects of the present disclosure. Beginning with FIG. 1A, FIG. 1A shows a number of hosts 105-117 residing on a network 102, including first host 105, second host 115, and additional hosts 117. The network 102 may include, for example, public networks (e.g., the Internet), private networks (e.g., LAN/WAN, virtual private cloud (VPC), etc.), and hybrid networks, among other network topologies and configurations. In some examples, the network 102 may be represented as a network overlay or logical network built on top of an underlying physical network, sometimes referred to as a fabric or network fabric. The network 102 represented as fabric may be a high-level substrate composed of multiple components and hosts 105-117 in network communication. In this regard, the network 102 may be provided by a fabric provider which establishes and configures the network 102 for use by the hosts 105-117.

The network 102 may include components such as a distributed object cache that stores source code, binaries, or other artifacts in local memories or shared memory spaces on the network 102. For example, the distributed object cache may maintain copies of an artifact in several cache servers distributed throughout the network so that, when requested, the file can be retrieved from a cache server with the highest instantaneous throughput or based on other network metrics. The network 102 may include shared memories. For example, for a deployment involving multiple federated components executing on the same host, separate processes may attach to a common shared-memory segment.

The network 102 may also include pools of threads or processes that can be shared among components or hosts for executing applications or other program code. Such shared thread pools or processes may be configured to share metadata such as authentication or authorization information. The shared information may be, for example, defined by an application's (e.g., a domain model's) specification. Likewise, application specifications may define shared control flows, which are ordered sequences of steps that make up a workflow associated with the application. For example, an application specification may define a control flow involving several steps, each of which is exposed as a method and executable by a suitably configured adapter. The control flow may be shared among several hosts, each host executing the control flow using a potentially different set of federated components.

In some examples, for remote components, the network 102 may be a self-forming peer-to-peer mesh. In this example, fabric components or hosts can auto-discover peers and automatically establish transient or persistent connections. The peer-to-peer mesh may cause network maintenance and operations such as propagating routing information, broadcasting telemetry, or sending versioning information without a central gateway.

The hosts 105-117 can be any suitable computing device, including servers, desktops, laptops, mobile devices, embedded or IoT devices, and the like. The hosts 105-117 may include one or more processors, memory, persistent storage, and one or more network interfaces. Each host may be executing various applications, at least some of which may invoke a runtime for invoking federated components provided by a fabric provider. The runtime can, for example, join a host to the fabric, communicate with a registry 155, retrieve executable components (e.g., precompiled WebAssembly modules), and so on.

Each host of the hosts 105-117 can be identified by a network address. In addition to executing applications, hosts 105-117 can be configured to perform various functions that support the network 102. For example, hosts 105-117 can coordinate runtime component needs; generate and receive telemetry; provide resources, services, or functionality for the network 102; or run software for communicating, sharing resources, or interacting with other hosts in the network 102. A host can perform various roles, such as acting as a central hub for other hosts, providing computational power, or facilitating communication between systems or users.

In the example shown in FIG. 1A, the first host 105 is executing an application 120, such as a web application in a web browser. The web application may be, for instance, a chatbot frontend that is backed by a distributed, federated large language model (LLM) backend or other AI workload. The LLM backend may include a number of different components, each of which can be a separately executed, standalone application and used by the first host 105. The executing application may include an operation 140A to be executed by a particular component of the LLM backend, such as a method. For example, the web application may call an “infer” method on a federated component that accepts a prompt as an argument and returns a response.

Invocation of the operation 140A may cause a runtime executing on the first host 105 join the first host 105 to the network 102, if it is not already joined. Then, the first host 105 can receive information about a second host 115 executing on the network 102, where the second host includes registry 155. The registry 155 may be a component of a pre-configured host (e.g., second host 115) that maintains a local database of deployed or deployable federated components. In some examples, the hosts 105-117 executing on the network 102 may be discoverable using a discovery mechanism such as multicast, which can also be used to populate the registry 155 database. In this case, the first host 105 can select the second host 115 using a peer-to-peer discovery protocol based on the multicast broadcasts.

The registry 155 can persist data about the active topology for the network 102. The information provided by the registry 155 may be persisted in one or more data sources (e.g., one or more databases). Likewise, there may be one or more registries according to the needs of the network 102. In some examples, application developers can use user interfaces (UIs) provided by the fabric provider to enable manual as well as programmatic access to real-time information about the network 102 and federated components at runtime.

In some examples, registry functionality may be provided using a manually configured local file on a host that includes default configuration with information such as locations (e.g., repository 150) of available sources for code or binary streaming. In addition to a file, other means for locally configuring hosts for registry-like functionality include the use of an environment variable or other system parameter configured to indicate available hosts, repositories, and so on.

The registry 155 can provide topology and component metadata about the network 102, including repository network locations. The repository 150 can provide the adapter 135 and federated component binaries (e.g., federated application 145) to hosts for execution. An adapter may include program code that encapsulates implementation details and other elements of an underlying operation that are not related to the business logic associated with the underlying operation. Adapters can serve to decouple business logic from the implementation-specific code required to communicate data across and among federated components. The adapter 135 can cause the operation 140A to execute on the first host 105 (depicted in FIG. 1A) or dispatch the operation 140A for execution on another host (depicted in FIG. 1B).

The second host 115 is shown as executing both the registry 155 and repository 150 for simplicity, but in various examples, the registry 155 and repository 150 may be executing on separate hosts, as well as having multiple redundant instances executing on various hosts.

The adapter 135 is sent to the first host by the repository 150 upon request. For example, the registry 155 may provide the network address of an available or recommended repository 150 to the first host 105. The first host 105 can output a request to the repository 150 to download the adapter 135. The adapter 135 can then execute the operation by either executing the federated application 145 implementing the operation 140A locally or causing the operation 140A to execute on another host.

The operation 140A may be implemented as a method or process of the federated application 145. The federated application 145 may include implementations of various methods according to a specification (e.g., an API specification). The adapter 135 connects the federated application 145 to other federated applications or hosts. In the example shown in FIG. 1A, the federated application 145 includes two operations 140A and 140B.

The federated application 145 may be an implementation of a specification referred to as a domain model. A domain model may include, for example, a set of definitions that specify the requirements of the federated application 145. The implementation of the domain model can encapsulate the business logic of the federated application 145 which is exposed via the adapter 135. Domain model definitions or specifications may involve program code (e.g., Java, JavaScript, Python, etc.), Unified Modeling Language (UML) sequence diagrams, state machine diagrams, low-code or no-code representations, or other representations.

The operations 140A and 140B (e.g., behaviors or actions) that a domain model can execute on the network 102 may be initiated using one or more ports provided by the federated application 145. Ports can provide a layer of separation between the business logic included in the domain model from implementation-specific code that is used by the adapter 135 to communicate with external entities on the network 102. Ports can be bound to the adapter 135 at runtime, which enables seamless re-binding for version updates without process restarts and allows the federated application 145 to change during execution. Such changes may be transparent to application 120, which may be agnostic, in some cases, to whether operation 140A is invoked locally or dispatches to a remote host.

In some examples, the application 120 may execute program code 125 that involves a number of different operations on different federated applications defined by respective domain models. A domain model collection is the collection of business logic components required to execute the program code 125 (e.g., a query or API invocation). The runtime 130 can maintain the domain model collection during execution of the program code 125. The model collection can have a complementary adapter collection, which includes the abstractions and executables necessary for directing data in and out of the domain models of the domain model collection.

In some examples, the first host 105 executing the federated application 145 can also provide a network-facing interface such as web server 160 which exposes the operations 140A and 140B or ports as API endpoints. Other examples of network interfaces include a remote procedure call (RPC) service endpoint, a WebSocket or server side events (SSE) service, a message broker interface, and so on. For example, each operation 140A, 140B may have a corresponding representational state transfer (REST) API endpoint accessible using an HTTP POST or GET request, along with suitable authentication and authorization information. The first host 105 may be configured to parse the domain model specification to auto-generate the API endpoints. In addition to a REST API, the web server 160 may provide custom route handlers such as webhook-callback receivers, event-ingestion endpoints, or asynchronous job-completion callbacks. The web server 160 can allow invocation of the operations 140A and 140B of the federated application 145 by other hosts operating in the network 102. In some examples, the operations 140A and 140B can be invoked using the facilities provided by the network 102 such as message-based execution, while the auto-generated web API endpoints can be used by external clients that are incompatible with the network 102 APIs.

FIG. 1A depicts the system 100 in which the federated application 145 is executing on the first host 105. In this case, the federated application 145 is not preinstalled on the first host 105. The first host 105 receives the federated application 145 from the repository 150. The adapter 135 then binds the operation 140A to the federated application 145 and causes the operation 140A to execute on the first host 105. The federated application 145 executes the operation 140A and returns a result to the application 120.

FIG. 1B depicts the system 100 in which the federated application 145 is executing on a third host 110, rather than on the first host 105 as shown in FIG. 1A. In this case, the adapter 135 binds the operation 140A to a remote execution path on the third host 110 and the operation 140A is executed by dispatching the call for execution using a publish-subscribe messaging system (e.g., Data Distribution Service (DDS)) or other means for remote execution. The request to execute the operation 140A is received by the web server 160, which is exposed by the third host 110 as described above. The web server 160 passes the request to the federated application 145, which executes the operation 140A and returns a result, via the web server 160. The result may be returned synchronously via an open connection or asynchronously using a mechanism with deferred completion such as futures or callback-based handles that are invoked when the operation 140A completes.

The adapter 135, federated application 145, and other executables may be distributed as source code, archives, or binary executables. For example, the adapter 135, federated application 145, and other executables may be distributed as precompiled WebAssembly (WASM) modules or files. WASM is a low-level, sandboxed bytecode format that executes inside a WASM runtime such as a web browser. Use of WASM can provide benefits such as portability, sandboxed execution, and dynamic loading and rebinding.

### Example Methods for Providing Federated Runtime Composition for Distributed Workloads

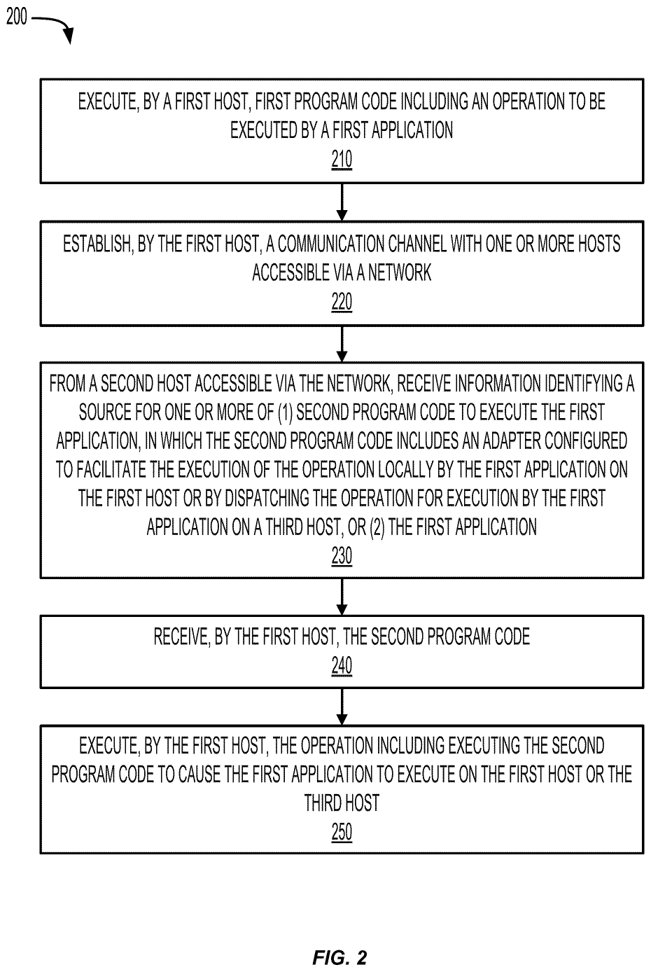

Referring now to FIG. 2, FIG. 2 shows a flowchart of an example method 200 for providing federated runtime composition for distributed workloads by a host, according to some aspects of the present disclosure. The description of the method 200 in FIG. 2 will be made with reference to FIGS. 1A and 1B, however any suitable system according to this disclosure may be applicable. It should be appreciated that method 200 provides a particular method for providing federated runtime composition for distributed workloads. Other sequences of operations may also be performed according to alternative examples. For example, alternative examples of the present disclosure may perform the steps outlined below in a different order. Moreover, the individual operations illustrated by method 200 may include multiple sub-operations that may be performed in various sequences as appropriate to the individual operation. Furthermore, additional operations may be added or removed depending on the particular applications. Further, the operations described in method 200 may be performed by different devices. For example, the description is given from the perspective of a host such as the first host 105 of FIGS. 1A and 1B but other configurations are possible. One of ordinary skill in the art would recognize many variations, modifications, and alternatives.

The method 200 may include block 210. At block 210, a computing system, such as the first host 105 of FIGS. 1A and 1B, executes first program code including an operation to be executed by a first application. The first program code may be, for example, a web application executing on the first host with dependencies on several federated microservices provided by a network or fabric provider. In another example, the first program code may be a frontend or interface for an AI application. For example, an AI application executing on the first host may use one federated application for initial data preprocessing on a nearby CPU, while a second federated application handles model inference on a remote machine equipped with specialized AI hardware.

The method 200 may include block 220. At block 220, the computing system establishes, by the first host, a communication channel with one or more hosts accessible via a network. For example, the first program code may include a runtime configured to establish the communication channel and to provide other functionality such as execution of adapters or federated applications (e.g., binding and executing adapters to ports provided by domain models). For instance, the runtime may be a JavaScript module or Java dependency which, upon import or process start, loads a WASM runtime engine and joins the fabric and prepares for execution of components such as adapters or federated applications. The communication channel may involve temporary or persistent connection using a suitable communications protocol. For example, if the network is a peer-to-peer mesh network, the first host can initiate a temporary connection over HTTPS, WebSocket, or plain TCP to discover metadata about fabric peer hosts and then establish a persistent TCP or WebRTC data channel to one or more discovered peers for continued participation in the network.

The method 200 may include block 230. At block 230, the computing system, from a second host accessible via the network, receives information identifying a source for one or more of (1) second program code to execute the first application, in which the second program code includes an adapter configured to facilitate the execution of the operation locally by the first application on the first host or by dispatching the operation for execution by the first application on a third host, or (2) the first application. The second host may be, for example, configured as a repository. In either case, the first application is not preinstalled on the first host.

In some examples, the second host may be selected by another host that is a member of the network that is configured as a registry for coordinating federated operations across the network. The registry may, in addition, provide additional data related to configuration of hosts and federated applications for deployment targets. For example, the registry can select the second host from among a number of available hosts. The selection may involve determining an available host based on telemetry generated by the various connected hosts.

The method 200 may include block 240. At block 240, the computing system receives the second program code. In some examples, the second program code may be sent by way of a distributed cache implemented by the network 102. For example, if the network is a peer-to-peer mesh network, then the distributed cache may be implemented as a sharded key-value store, in which the various shards are stored on hosts throughout the mesh that can be located using a hash derived from the second program code.

The method 200 may include block 250. At block 250, the computing system executes the operation including executing the second program code to cause the first application to execute on the first host or the third host. The adapter included with the second program code may be configured to determine, based on the operation and telemetry generated by the various hosts connected to the network, whether to cause the operation to execute via the first application on the first host or to dispatch the operation for execution by the first application on the third host.

If the adapter determines that the first application will execute on the first host, the first application may be downloaded or streamed to the first host from the second host (or another repository). The adapter can then bind the operation to the first application on the first host, such that invocations of the operation in the first program code will cause the operation to execute using the first application on the first host via the adapter. That is, the first application will execute locally on the first host along with the calling first program code. In some examples, the first application is not installed on the first host. The first application is streamed, in executable format, to the first host and then executed while the first application resides in-memory.

If, on the other hand, the adapter determines that the first application will execute on a different host, then the adapter can bind the operation to a remote execution path on a third host. Then, the operation can be dispatched for execution by the first application on the third host and the first application (and the operation) will accordingly execute on the third host. In this case, the first application executes remotely on the third host, while the calling first program code executes locally on the first host. If the third host is not already in receipt of the latest version of the first application, it may first be downloaded or streamed to the third host from the second host (or another repository).

The adapter thus provides an interface to the network or fabric for remote execution of the first application. The calling first program code is insulated from the implementation details of the remote execution. In some examples, dispatching the operation for execution by the first application on the remote third host may involve publishing, using a publish-subscribe messaging system, a request message to a topic associated with the first application. The publish-subscribe messaging system may be, for example, the Data Distribution Service (DDS). Other publish-subscribe messaging systems or event-driven or messaging buses may be used to similar effect. For example, the publish-subscribe messaging system may be implemented using a message broker (e.g., RabbitMQ) or a distributed messaging platform (e.g., Apache Kafka).

One advantage of the techniques for federated runtime composition for distributed workloads, according to this disclosure, involves enablement of seamless updates to the first application that are handled by the network or fabric. For example, if a developer pushes a new version of the first application to the repository, the first host may receive an indication of the new version. The indication may be, for example, a registry entry or update flag associated with the first application. The first host may be configured to automatically receive such update information via a subscription or other notification mechanism.

In the local execution case, after receiving the indication, the first host then receives the new version of the first application. The new version may be automatically sent or downloaded. Then, the first host can replace an executing instance of the first application with the new version by rebinding, via the adapter, the operation to the new version of the first application. The first application may be replaced without interruption to ongoing executions or operations. For example, the first application can be replaced without terminating active client connections and thereby maintaining active, persistent connections that may be open.

In the remote execution case, after receiving the indication, the first host outputs a command via the adapter to cause the third host to retrieve the new version of the first application. The first host continues to dispatch, via the adapter, the operation to the third host for execution; however, the new version of the first application on the third host will now be executed. Once again, the first application may be replaced without interruption to ongoing executions or operations.

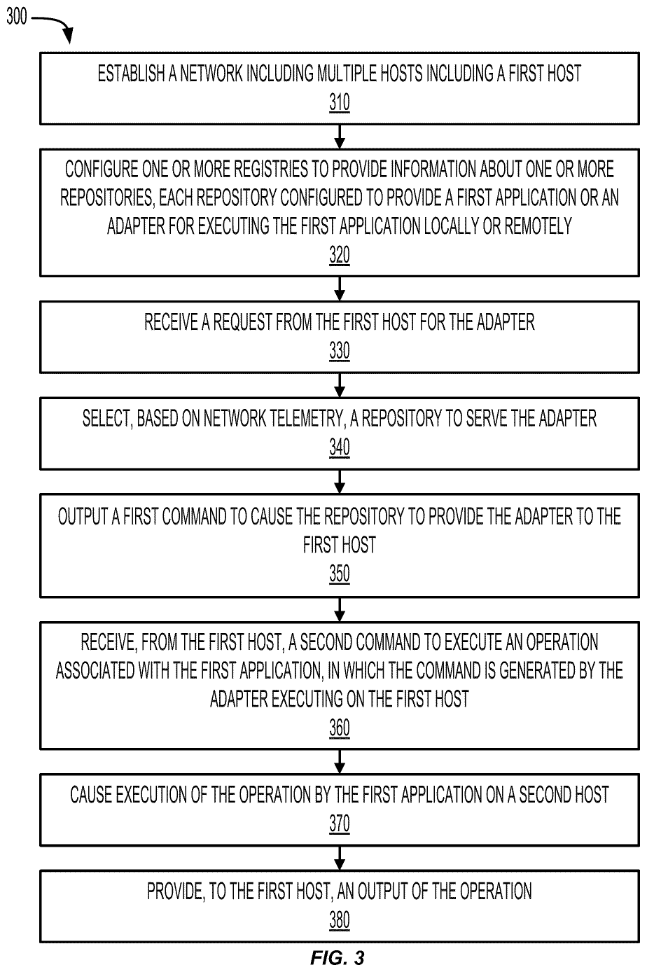

Referring now to FIG. 3, FIG. 3 shows a flowchart of an example method 300 for providing federated runtime composition for distributed workloads by a network provider, according to some aspects of the present disclosure. The description of the method 300 in FIG. 3 will be made with reference to FIGS. 1A and 1B, however any suitable system according to this disclosure may be applicable. It should be appreciated that method 300 provides a particular method for providing federated runtime composition for distributed workloads. Other sequences of operations may also be performed according to alternative examples. For example, alternative examples of the present disclosure may perform the steps outlined below in a different order. Moreover, the individual operations illustrated by method 300 may include multiple sub-operations that may be performed in various sequences as appropriate to the individual operation. Furthermore, additional operations may be added or removed depending on the particular applications. Further, the operations described in method 300 may be performed by different devices. For example, the description is given from the perspective of a network provider such as the network provider for the network 102 of FIGS. 1A and 1B but other configurations are possible. One of ordinary skill in the art would recognize many variations, modifications, and alternatives.

The method 300 may include block 310. At block 310, a network provider such as the network provider for the network 102 of FIGS. 1A and 1B, establishes a network including multiple hosts including a first host. The network may be abstracted using logical network overlay referred to as a fabric. The fabric may be a self-forming mesh of peer-to-peer connected hosts. The fabric may be configured to provide hosts using federated software components executables, program code, and associated data under various network conditions and topologies.

The hosts may include any suitable computing device or system for configuring or executing federated components. In general, the multiple hosts can provide an environment within which federated components are deployed. Examples of host capabilities include provisioning, loading, and maintaining federated components; loading deployment configurations; hosting federated applications; parsing federated application specifications (e.g., domain models); composing applications using federated microservices and other components; binding adapters to operations (e.g., domain model ports) at runtime upon system startup or following updates to federated applications; discovering adapters, services, or components on the network; initiating and querying distributed caches; listening for events on the network; and other functionality.

The method 300 may include block 320. At block 320, the network provider configures one or more registries to provide information about one or more repositories, each repository configured to provide a first application or an adapter for executing the first application locally or remotely. Each registry may be deployed to a host (e.g., system 100 of FIGS. 1A and 1B) but may also be deployed as a standalone computing system. Each registry can maintain a mapping of the hosts, registries, repositories, and other components deployed to the network or portion thereof.

The method 300 may include block 330. At block 330, the network provider receives a request from the first host for the adapter. For example, the request may be routed from the first host via network peers according to each host's local forwarding table until received by a registry. The request may include a specification of an operation associated with the first application, a federated application. For example, the first host may be executing a web or native application locally that calls a method on the first application, which is not installed on the first host.

The method 300 may include block 340. At block 340, the network provider selects, based on network telemetry, a repository to serve the adapter. For example, the registry may be configured to monitor telemetry for the network or a portion thereof. More generally, the hosts making up the network may individually monitor network telemetry and share collected data with the other hosts on the network. Software for the telemetry may be included in the host runtimes deployed to each host. The registry can identify a repository to serve the first host's request based on the network conditions as evidenced by the network telemetry.

The method 300 may include block 350. At block 350, the network provider outputs a first command to cause the repository to provide the adapter to the first host. For example, the registry can, after identifying the repository, output a command to the repository at the corresponding network address including instructions to send the adapter to the network address of the first host along with authentication and authorization details. The repository can send the adapter to the first host as a file, as a file stream, by specifying a download location, and so on.

The method 300 may include block 360. At block 360, the network provider receives, from the first host, a second command to execute an operation associated with the first application, in which the command is generated by the adapter executing on the first host. For example, the second command may be received and routed by a registry. In other examples, the first host may broadcast an event, via the adapter, including the second command indicating the desired operation to be executed. The event may be consumed by a messaging system such as DDS. The messaging system can provide a publish/subscribe interface which can selectively communicate information among hosts and other network components. Such event-based execution and communication over the fabric may be referred to as “eventing.”

The method 300 may include block 370. At block 370, the network provider causes execution of the operation by the first application on a second host. For example, in the event-based paradigm, the messaging system can route the second command to the second host onto which the first application is deployed to cause the execution of the operation by the first application.

The method 300 may include block 380. At block 380, the network provider provides, to the first host, an output of the operation. For example, following execution of the operation, the second host may output an event including information about the requesting first host and the result of the operation. For instance, if the operation requested by the first host was an inference operation involving a federated component of a machine learning model, then the result may include data resulting from the inference operation along with suitable metadata.

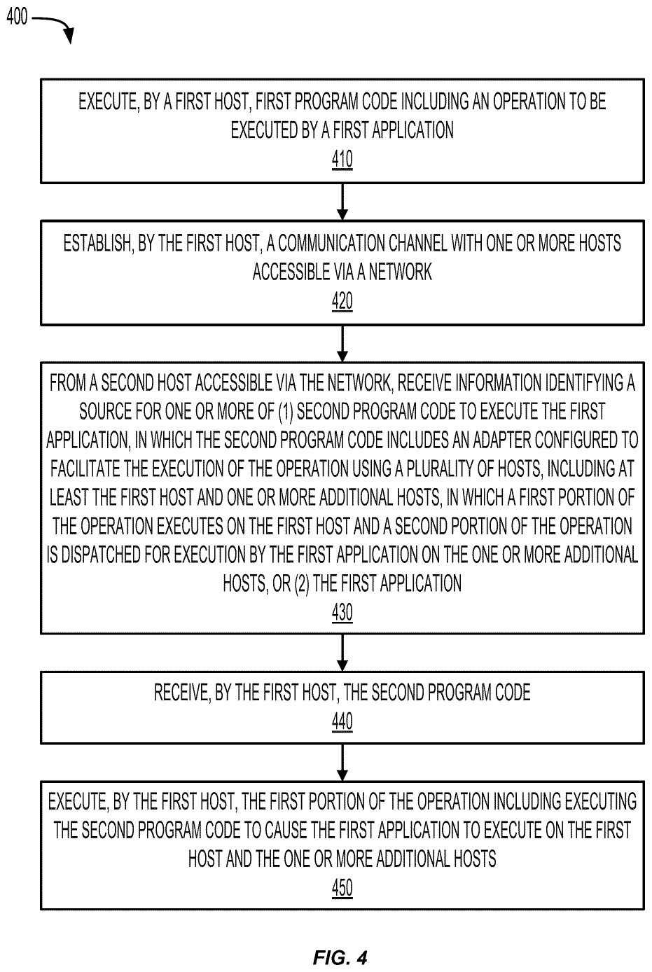

Referring now to FIG. 4, FIG. 4 shows a flowchart of an example method 400 for providing federated runtime composition for distributed workloads by multiple hosts, according to some aspects of the present disclosure. The description of the method 400 in FIG. 4 will be made with reference to FIGS. 1A and 1B, however any suitable system according to this disclosure may be applicable. It should be appreciated that method 400 provides a particular method for providing federated runtime composition for distributed workloads. Other sequences of operations may also be performed according to alternative examples. For example, alternative examples of the present disclosure may perform the steps outlined below in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices. For example, the description is given from the perspective of multiple hosts such as the first host 105 of FIGS. 1A and 1B but other configurations are possible. One of ordinary skill in the art would recognize many variations, modifications, and alternatives.

The method 400 may include block 410. At block 410, a computing system, such as the first host 105 of FIGS. 1A and 1B, executes first program code including an operation to be executed by a first application. Block 410 may be performed substantially as described with respect to block 210 of FIG. 2.

The method 400 may include block 420. At block 440, the computing system establishes a communication channel with one or more hosts accessible via a network. Block 420 may be performed substantially as described with respect to block 220 of FIG. 2.

The method 400 may include block 420. At block 440, the computing system, from a second host accessible via the network, receives information identifying a source for one or more of (1) second program code to execute the first application, in which the second program code includes an adapter configured to facilitate the execution of the operation using multiple hosts, including at least the first host and one or more additional hosts, in which a first portion of the operation executes on the first host and a second portion of the operation is dispatched for execution by the first application on the one or more additional hosts, or (2) the first application.

Block 430 may be performed substantially as described with respect to block 230 of FIG. 2, except that the adapter may be configured to coordinate hybrid execution of the operation across the multiple hosts. In other words, rather than executing the operation on the first host or on a remote third host, as described above with respect to block 230, the adapter may use an allocation process to distribute different portions of the operation across the multiple hosts based factors such as the computational requirements of each portion, the resources available on each host according to telemetry gathered from the network, storage availability, among others.

For example, consider an inference operation for an AI workload that is parallelizable. The adapter can segment the inference operation into parallelizable stages or parallelizable portions of a stage. The adapter can designate a host or hosts to execute each portion of the inference and execute locally or dispatch for remote execution as appropriate. For instance, the adapter may execute preprocessing such as tokenization on the first host and send the computational inference steps to a GPU host.

The method 400 may include block 440. At block 440, the computing system receives the second program code. Block 440 may be performed substantially as described with respect to block 240 of FIG. 2.

The method 400 may include block 450. At block 450, the computing system executes the first portion of the operation including executing the second program code to cause the first application to execute on the first host and the one or more additional hosts, in which the adapter of the second program code distributes execution of the operation across the multiple hosts and aggregates results from the multiple hosts. Continuing the example above, the as the portions finish executing, the results of those parallelizable operations can be returned to the first host (or another host) and combined to generate the result of the inference operation. In some cases, the adapter may generate intermediate results and dispatch additional portions of the operation for execution locally or remotely. The operation can be, in this example, completed by a series of distributed parallelized executions of portions of the operation.

In some examples, the adapter can coordinate partial execution of portions of the operation. For example, parallelizable portions may be partially executed, stopped, and then later resumed as computational resources become available. Partial execution of portions of operations may be useful when numerous operations are executed across the network with variable priorities. Higher priority operations may preempt access to hosts, causing in-flight operations or portions of operations to halt, while the higher-priority operations (or portions) proceed. Then, once the higher-priority operation is completed, execution of the paused operation (or portion) can resume.

### Example Computing Environment

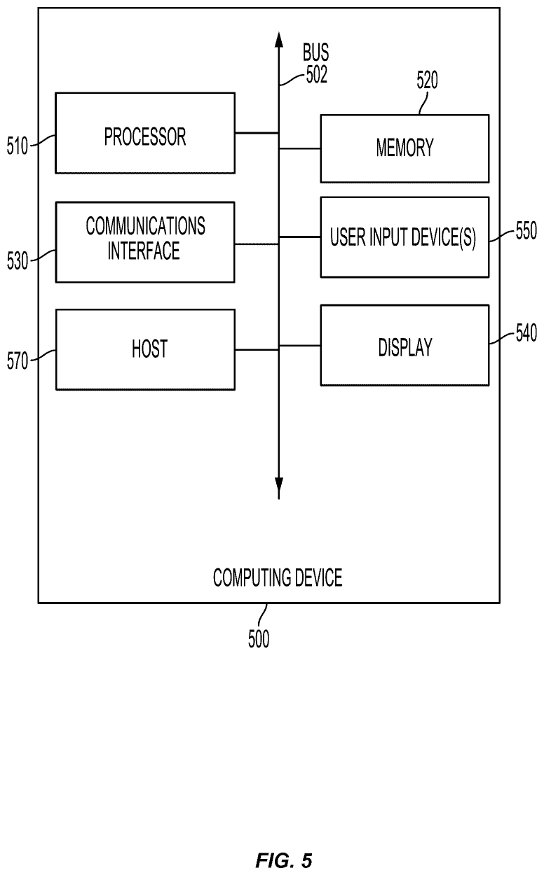

Referring now to FIG. 5, FIG. 5 shows an example computing device 500 suitable for use in example systems or methods for providing federated runtime composition for distributed workloads, according to some examples of the present disclosure. The example computing device 500 includes a processor 510 which is in communication with the memory 520 and other components of the computing device 500 using one or more communication buses 502, including the host 570 (or components thereof). The host 570 may be similar to the hosts 105-117 as described above in FIGS. 1A and 1B. The processor 510 is configured to execute processor-executable instructions stored in the memory 520 to perform one or more methods for providing federated runtime composition for distributed workloads according to different examples, such as part or all of the example methods 200 and 300 described above with respect to FIGS. 2 and 3. In distributed or federated deployments, the processor 510 may exchange information with local components via the buses 502. In such deployments, the memory 520 can store shared state associated with other computing devices or components that are part of the federated deployment.

The computing device 500, in this example, also includes one or more user input devices 550, such as a keyboard, mouse, touchscreen, microphone, etc., to accept user input. The computing device 500 also includes a display 540 to provide visual output to a user.

The computing device 500 also includes a communications interface 530. In some examples, the communications interface 530 may enable communications using one or more networks, including a local area network (LAN); wide area network (WAN), such as the Internet; metropolitan area network (MAN); point-to-point or peer-to-peer connections; etc. Communication with other devices may be accomplished using any suitable networking protocol. For example, one suitable networking protocol may include the Internet Protocol (IP), Transmission Control Protocol (TCP), User Datagram Protocol (UDP), or combinations thereof, such as TCP/IP or UDP/IP. In distributed or federated configurations, the communications interface 530 can send task requests, intermediate data, or synchronization messages to other computing devices, and may receive corresponding responses or updates needed for coordinated execution across the distributed or federated application. In some examples, communication among computing devices may occur via the communications interface 530 using queue-based or publish/subscribe message buses, such as the Data Distribution Service (DDS), Advanced Message Queuing Protocol (AMQP), Message Queuing Telemetry Transport (MQTT), or the like.

While some examples of methods and systems herein are described in terms of software executing on various machines, the methods and systems may also be implemented as specifically configured hardware, such as a field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor is coupled to a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable media may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

### General Consideration

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4).

Example 1 is a method, including: executing, by a first host, first program code may include an operation to be executed by a first application; establishing, by the first host, a communication channel with one or more hosts accessible via a network; from a second host accessible via the network, receiving information identifying a source for one or more of (1) second program code to execute the first application, where the second program code may include an adapter configured to facilitate the execution of the operation locally by the first application on the first host or by dispatching the operation for execution by the first application on a third host, or (2) the first application; receiving, by the first host, the second program code; and executing, by the first host, the operation may include executing the second program code to cause the first application to execute on the first host or the third host.

Example 2 is the method as example 1 describes, where the adapter is configured to determine, based on the operation and telemetry generated by the one or more hosts, whether to cause the operation to execute via the first application on the first host or to dispatch the operation for execution by the first application on the third host.

Example 3 is the method as either of examples 1 or 2 describe, where: the first application may include a domain model; and the host executing the first application further may include a network interface, where the operation is exposed by the network interface as an application programming interface (API) endpoint.

Example 4 is the method as any of examples 1-3 describe, where: the operation corresponds to a port of the domain model; and executing the operation further may include binding the adapter of the second program code to a first port of the domain model to execute the operation.

Example 5 is the method as any of examples 1-4 describe, further may include: receiving, by the first host, the first application; and binding, by the first host via the second program code, the operation to the first application on the first host, where the second program code causes the operation to execute via the first application on the first host.

Example 6 is the method as any of examples 1-5 describe, further may include: receiving, by the first host, an indication of a new version for the first application; receiving, by the first host, the new version of the first application; and replacing, by the first host, an executing instance of the first application with the new version by rebinding, via the second program code, the operation to the new version of the first application.

Example 7 is the method as any of examples 1-6 describe, where: the second program code binds the operation to a remote execution path on the third host, where the operation is dispatched for execution by the first application on the third host; and the first application executes on the third host.

Example 8 is the method as any of examples 1-7 describe, where dispatching the operation for execution by the first application on the third host may include outputting a request message to a messaging bus provided by the network.

Example 9 is the method as any of examples 1-8 describe, further may include: receiving, by the first host, an indication of a new version for the first application; outputting a command, by the first host via the second program code, to cause the third host to retrieve the new version of the first application; and dispatching, by the first host via the second program code, the operation to the new version of the first application on the third host.

Example 10 is the method as any of examples 1-9 describe, where the indication of the new version for the first application may include a registry entry or update flag associated with the first application on the third host.

Example 11 is the method as any of examples 1-10 describe, where: the network may include a self-forming peer-to-peer mesh network; and the method further may include joining, by the first host, the peer-to-peer mesh network, where the peer-to-peer mesh network may include a plurality of connected hosts including the first host.

Example 12 is the method as any of examples 1-11 describe, where: the network further may include a distributed cache; and the second program code is received from the distributed cache.

Example 13 is the method as any of examples 1-12 describe, where the second program code and the first application may include precompiled WebAssembly (WASM) binary executables.

Example 14 is the method as any of examples 1-13 describe, where receiving the information about the second host executing on the network may include: selecting, by a fourth host of the one or more hosts, the second host from the one or more hosts may include determining an available host based on telemetry generated by the one or more hosts.

Example 15 is the method as any of examples 1-14 describe, where the first host selects the second host using a peer-to-peer discovery protocol based on multicast.

Example 16 is the method as any of examples 1-15 describe, where the first program code may include a runtime configured to join the network and execute the second program code or the first application.

Example 17 is the method as any of examples 1-16 describe, where: the first host is a first client device; and the first program code may include a web application executing in a web browser installed on the first client device.

Example 18 is the method as any of examples 1-17 describe, where the first application is not preinstalled on the first host.

Example 19 is a non-transitory computer-readable storage medium storing processor-executable instructions configured to cause one or more processors to: execute, by a first host, first program code may include an operation to be executed by a first application; establish, by the first host, a communication channel with one or more hosts accessible via a network; from a second host accessible via the network, receive information identifying a source for one or more of (1) second program code to execute the first application, where the second program code may include an adapter configured to facilitate the execution of the operation locally by the first application on the first host or by dispatching the operation for execution by the first application on a third host, or (2) the first application; receive, by the first host, the second program code; and execute, by the first host, the operation may include executing the second program code to cause the first application to execute on the first host or the third host.

Example 20 is a system, including: one or more non-transitory computer-readable media; and one or more processors communicatively coupled to the one or more non-transitory computer-readable media, the one or more processors configured to execute processor-executable instructions stored in the non-transitory computer-readable media to: execute, by a first host, first program code may include an operation to be executed by a first application; establish, by the first host, a communication channel with one or more hosts accessible via a network; from a second host accessible via the network, receive information identifying a source for one or more of (1) second program code to execute the first application, where the second program code may include an adapter configured to facilitate the execution of the operation locally by the first application on the first host or by dispatching the operation for execution by the first application on a third host, or (2) the first application; receive, by the first host, the second program code; and execute, by the first host, the operation may include executing the second program code to cause the first application to execute on the first host or the third host.

What is claimed is:

1. A method, comprising:
executing, by a first host, first program code comprising an operation to be executed by a first application;
establishing, by the first host, a communication channel with one or more hosts accessible via a network;
from a second host accessible via the network, receiving information identifying a source for one or more of (1) second program code to execute the first application, wherein the second program code comprises an adapter configured to facilitate the execution of the operation locally by the first application on the first host or by dispatching the operation for execution by the first application on a third host, or (2) the first application;
receiving, by the first host, the second program code; and
executing, by the first host, the operation comprising executing the second program code to cause the first application to execute on the first host or the third host.

2. The method of claim 1, wherein the adapter is configured to determine, based on the operation and telemetry generated by the one or more hosts, whether to cause the operation to execute via the first application on the first host or to dispatch the operation for execution by the first application on the third host.

3. The method of claim 1, wherein:
the first application comprises a domain model; and
the host executing the first application further comprises a network interface, wherein the operation is exposed by the network interface as an application programming interface (API) endpoint.

4. The method of claim 3, wherein:
the operation corresponds to a port of the domain model; and
executing the operation further comprises binding the adapter of the second program code to a first port of the domain model to execute the operation.

5. The method of claim 1, further comprising:
receiving, by the first host, the first application; and
binding, by the first host via the second program code, the operation to the first application on the first host, wherein the second program code causes the operation to execute via the first application on the first host.

6. The method of claim 5, further comprising:
receiving, by the first host, an indication of a new version for the first application;
receiving, by the first host, the new version of the first application; and
replacing, by the first host, an executing instance of the first application with the new version by rebinding, via the second program code, the operation to the new version of the first application.

7. The method of claim 1, wherein:
the second program code binds the operation to a remote execution path on the third host, wherein the operation is dispatched for execution by the first application on the third host; and
the first application executes on the third host.

8. The method of claim 7, wherein dispatching the operation for execution by the first application on the third host comprises outputting a request message to a messaging bus provided by the network.

9. The method of claim 7, further comprising:
receiving, by the first host, an indication of a new version for the first application; outputting a command, by the first host via the second program code, to cause the third host to retrieve the new version of the first application; and
dispatching, by the first host via the second program code, the operation to the new version of the first application on the third host.

10. The method of claim 9, wherein the indication of the new version for the first application comprises a registry entry or update flag associated with the first application on the third host.

11. The method of claim 1, wherein:
the network comprises a self-forming peer-to-peer mesh network; and
the method further comprises joining, by the first host, the peer-to-peer mesh network, wherein the peer-to-peer mesh network comprises a plurality of connected hosts including the first host.

12. The method of claim 11, wherein:
the network further comprises a distributed cache; and
the second program code is received from the distributed cache.

13. The method of claim 1, wherein the second program code and the first application comprise precompiled WebAssembly (WASM) binary executables.

14. The method of claim 1, wherein receiving the information about the second host executing on the network comprises:
selecting, by a fourth host of the one or more hosts, the second host from the one or more hosts comprising determining an available host based on telemetry generated by the one or more hosts.

15. The method of claim 14, wherein the first host selects the second host using a peer-to-peer discovery protocol based on multicast.

16. The method of claim 1, wherein the first program code comprises a runtime configured to join the network and execute the second program code or the first application.

17. The method of claim 1, wherein:
the first host is a first client device; and
the first program code comprises a web application executing in a web browser installed on the first client device.

18. The method of claim 1, wherein the first application is not preinstalled on the first host.

19. A non-transitory computer-readable storage medium storing processor-executable instructions configured to cause one or more processors to:
execute, by a first host, first program code comprising an operation to be executed by a first application;
establish, by the first host, a communication channel with one or more hosts accessible via a network;
from a second host accessible via the network, receive information identifying a source for one or more of (1) second program code to execute the first application, wherein the second program code comprises an adapter configured to facilitate the execution of the operation locally by the first application on the first host or by dispatching the operation for execution by the first application on a third host, or (2) the first application;
receive, by the first host, the second program code; and
execute, by the first host, the operation comprising executing the second program code to cause the first application to execute on the first host or the third host.

20. A system, comprising:
one or more non-transitory computer-readable media; and
one or more processors communicatively coupled to the one or more non-transitory computer-readable media, the one or more processors configured to execute processor-executable instructions stored in the non-transitory computer-readable media to:
execute, by a first host, first program code comprising an operation to be executed by a first application;
establish, by the first host, a communication channel with one or more hosts accessible via a network;
from a second host accessible via the network, receive information identifying a source for one or more of (1) second program code to execute the first application, wherein the second program code comprises an adapter configured to facilitate the execution of the operation locally by the first application on the first host or by dispatching the operation for execution by the first application on a third host, or (2) the first application;
receive, by the first host, the second program code; and
execute, by the first host, the operation comprising executing the second program code to cause the first application to execute on the first host or the third host.
